(19) United States
(12) Patent Application Publication
(10) Pub. No.: US 2005/0038797 A1
(43) Pub. Date: Feb. 17, 2005

(54) Information processing and database searching

(75) Inventor: Keizo Tabuchi, Tokyo-to (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armond, NY (US)

(21) Appl. No.: 10/911,305

(22) Filed: Aug. 4, 2004

(30) Foreign Application Priority Data
Aug. 12, 2003 (JP) 2003-292210

(51) Int. Cl. G06F 17/00

(52) U.S. Cl. 707/100

(57) ABSTRACT

Eliminates use of operations performed by a user to specify desired knowledge and information in an information search so as to reduce trouble for the user. An information processing system is constituted by including a server having a database and a client connected to the server via a network. The client specifies a method of extracting a keyword to be used for a database search based on a pattern of a predetermined information activity such as exchange of e-mail, and extracts the keyword to be used for the database search from a text obtained through the predetermined information activity and sends it to the server. And the server receives and holds the keyword sent from the client, performs the database search using the keyword as a search condition in predetermined timing without a search request from the client and sends a search result to the client.

### FIELD OF THE INVENTION

The present invention relates to an information search system for performing an information search for a database, and in particular, to the information search system for automatically searching knowledge and information useful to a user from the database and providing it.

### BACKGROUND

Consideration is made below of the following documents:
[Patent Document 1] Published Unexamined Patent Application No. 2001-282792
[Nonpatent Document 1] “CIO Online Emerging Technology,” [online], IDG Japan, [searched on Jul. 26, 2003], Internet <URL:http://www.idg.co.jp/CIO/contents/emerging/emerging1.html>

As a basic technique for information search used in knowledge management and so on, there is a method of having information resources (knowledge) held by each user such as a member of an organization registered with a database and having the database searched by the user requiring predetermined knowledge and information to obtain desired knowledge and information (refer to Patent Document 1 for instance).

Furthermore, there is also a prior method resulting in reduced difficulty of the user by actively providing the information desired by the user from a database side. To be more specific, it is a system in which the user clarifies his or her necessary information and the information in an applicable category is automatically notified to the user in the case where such information is registered with the database (refer to Nonpatent Document 1 for instance). According to this prior art, the information desired by the user is automatically provided from the database side each time it is registered with the database. Therefore, the user does not need to perform an operation for the search each time, and besides, current information in the category desired by the user is provided at any time so that an efficient information search is possible.

As mentioned above, various techniques of information search for a database using a computer have been proposed so far. However, the above past techniques of information search took the trouble of informing the database of what knowledge and information are desired by having a kind of category or a keyword inputted by a user in order to obtain the desired knowledge and information.

As for the method disclosed in Nonpatent Document 1, it is not necessary to input information for a search such as the kind of category or keyword each time the user performs the information search. However, it takes commensurate difficulty in that the user needs to select such information in advance via active operations of the user himself or herself and register it with the database.

### SUMMARY OF THE INVENTION

To overcome the above-mentioned problems of the prior art, an aspect of the present invention is to eliminate the use of the operations performed by the user to specify the desired knowledge and information in the information search so as to reduce trouble to the user.

Another aspect of the present invention is to provide an information processing system capable of selecting the knowledge and information considered useful for the user from the database based on information activities of the user and actively providing it.

To attain the aspects, the present invention is implemented as an information processing system including a database server and a client connected to the database server via a network. The client extracts a keyword to be used for a database search from a text obtained through predetermined information activity and sends it to the database server. The database server receives the keyword sent by the client, performs the database search using the keyword as a search condition and sends the search result to the client.

The present invention may also be implemented as a database search method characterized by including the steps of extracting, from text obtained through predetermined information activity, a keyword to be used for the database search by a keyword extracting method specified based on the analysis result of a pattern of the information activity, storing the extracted keyword in predetermined keyword storing means, and performing the database search by using the keyword stored in the keyword storing means.

### BRIEF DESCRIPTION OF THE FIGURES

The foregoing and other aspects, and advantages will be better understood from the following non-limiting detailed description of embodiments of the invention with reference to the drawings that include the following:

FIG. 1 is a diagram showing an overall configuration of an information processing system in which information processing according to the present invention is utilized;

FIG. 2 is a diagram schematically showing an example of hardware configuration of a computer apparatus suitable for implementing a server and a client according to the present invention;

FIG. 3 is a diagram showing a functional configuration of the client according to the present invention;

FIG. 4 is a flowchart for explaining a keyword extraction process by a keyword extracting unit according to the present invention;

FIG. 5 is a table showing criteria for classifying e-mail based on whether the client is a receiver or a provider of information according to the present invention;

FIG. 6 is a diagram showing the functional configuration of the server according to the present invention;

FIG. 7 is a diagram showing a configuration example of data to be stored in a keyword management DB according to the present invention;

FIG. 8 is a diagram showing an appearance of having updated the keywords associated with an e-mail address “ ” in the keyword management DB in FIG. 7;

FIG. 9 is a flowchart showing an overall processing flow of the information processing system of the present invention;

FIG. 10 is a diagram showing the functional configuration of the client in the case where the information activity of the client is the cooperative work by a plurality of computers by using collaboration software; and

FIG. 11 is a diagram showing the functional configuration of the server in the case where the information activity of the client is the cooperative work by a plurality of computers by using the collaboration software.

### DESCRIPTION OF SYMBOLS

10, 30 . . . Servers
11 . . . Information resource management DB (database)
12 . . . Search executing unit
13 . . . Keyword management DB
14 . . . Sending and receiving control unit
20, 40 . . . Clients
21 . . . Mailbox
22 . . . Keyword extracting unit
23 . . . Sending and receiving control unit
24 . . . Output control unit
31 . . . Optimum network structure processing unit
32 . . . User profile DB
41 . . . Message repository
50 . . . Network
101 . . . CPU (Central Processing Unit)
103 . . . Main memory
105 . . . Disk storage drive (HDD)
106 . . . Network interface

### DETAILED DESCRIPTION OF THE INVENTION

The present invention provides methods, systems and apparatus to eliminate the use of the operations performed by the user to specify the desired knowledge and information in the information search so as to reduce the trouble for the user. It also provides an information processing system capable of selecting the knowledge and information considered useful for the user from the database based on information activities of the user and actively providing it.

In an example embodiment, the present invention is implemented as an information processing system constituted as follows. The information processing system includes a database server and a client connected to the database server via a network. The client extracts a keyword to be used for a database search from a text obtained through a predetermined information activity and sends it to the database server. The database server receives the keyword sent by the client, performs the database search using the keyword as a search condition and sends the search result to the client.

To describe it in further detail, the information processing apparatus to be used as the client comprises a text holding unit for holding a text obtained through a predetermined information activity, a keyword extracting unit for analyzing a pattern of the information activity, specifying a method of extracting a keyword to be used for a database search based on the analysis result, and extracting the keyword from the text held by the text holding unit by the specified extracting method. It also comprises a communication control unit for sending the keyword extracted by the keyword extracting unit as a search condition to a database server on a network and an output control unit for outputting the result of the database search using the keyword extracted by the keyword extracting unit.

The keyword extracting unit more preferably selects as a subject of extraction of the keyword the text determined to have been obtained through the information activity performed to obtain predetermined information based on the analysis result of the pattern of the information activity. To be more precise, the keyword extracting unit extracts as the keywords a predetermined number of words of a high frequency of appearance out of the words obtained by performing a morphological analysis of the text held by the text holding unit.

It is also possible, for example, to constitute the text holding unit with a mailbox having e-mail exchanged with external devices stored therein and constitute the keyword extracting unit to analyze sending and receiving actions of the e-mail stored in the text holding unit as a pattern of the information activity and select the e-mail based on the analysis result as a subject of extraction of the keyword so as to extract the keyword. To be more precise, in the case where the sending and receiving actions of the e-mail in a predetermined thread start with receiving only or sending and ends with the sending after a predetermined number of times of the sending and receiving, it selects the e-mail in the thread to extract a keyword therefrom. It is also possible to analyze the sending and receiving actions and determine for each thread whether the sending and receiving have been performed to provide predetermined information or to obtain the predetermined information so as to extract the keyword from predetermined e-mail based on the determination result.

It is also possible, as another example, to constitute the text holding unit with a message repository for storing a nontypical message exchanged in chatting, a message board and so on and constitute the keyword extracting unit to analyze a tree structure of a message and whether or not a question word and a question mark are included in a nontypical message as the pattern of the information activity so as to select the message to be the subject of extraction of the keyword and extract the keyword.

Furthermore, the database server in this information processing system holds the keyword received from the client, and in the case where new information related to the keyword is registered with the database, it searches for the new information and sends it to the client. And the database server performs the database search using the held keyword in predetermined timing without an explicit search request from the client and sends the search result to the client.

Furthermore, the information processing system may be constituted so that, as to the keyword, the client sends to the database server the information indicating whether the client apparatus has been a receiver or a provider of the information in the information activity through which a text as a source of extraction of the keyword has been obtained, and as to a predetermined keyword of the keywords sent from the client, the database server sends the information on the client having sent the keyword as the provider of the information to the client having sent the keyword as the receiver of the information.

The present invention may also be implemented as the following database search method constructed by using a computer. The search method is characterized by comprising steps of extracting, from a text obtained through a predetermined information activity, a keyword to be used for the database search by the keyword extracting method specified based on the analysis result of a pattern of the information activity, storing the extracted keyword in predetermined keyword storing means, and performing the database search by using the keyword stored in the keyword storing means.

Furthermore, the present invention may also be implemented as a program product for controlling the computer to function as the above-mentioned information processing apparatus or a program product for causing the computer to execute a process corresponding to each step of the database search method. This program can be provided by storing it in a magnetic disk, an optical disk, a semiconductor memory and other recording media and distributing it or delivering it via a network.

According to the present invention constituted as above, it is possible to hold the keyword extracted by the client on the server, perform the database search based on this keyword without the explicit search request from the client and provide the search result to the client so as to eliminate the use of the operations performed by the user to specify the desired knowledge and information such as issuing the search request and registering the search condition and thereby significantly reduce the trouble for the user.

According to the present invention, the server automatically performs the search without the explicit search request from the client and registration of the search condition and provides the search result to the client. Therefore, it has the effect of actively providing the knowledge and information considered useful for the user from the information processing system side.

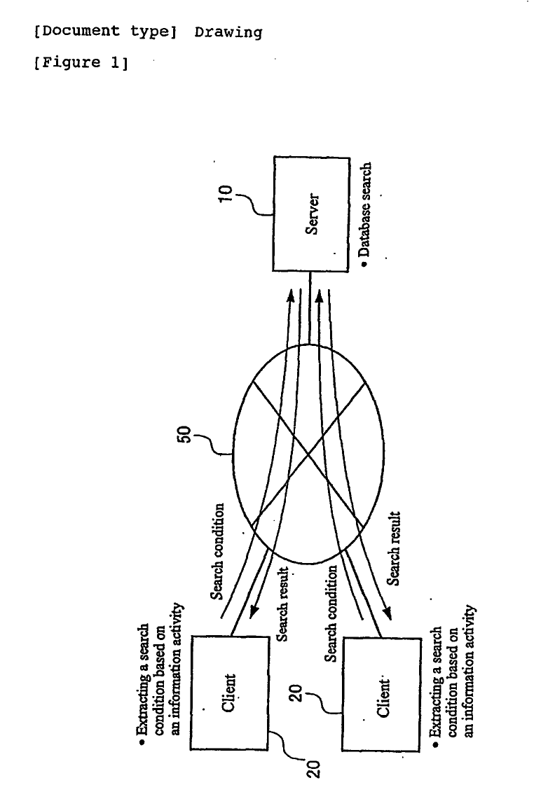

Hereafter, an advantageous embodiment for implementing the present invention (hereafter, the embodiment) will be described in detail by referring to the attached drawings. FIG. 1 is a diagram showing an overall configuration of an information processing system in which information processing according to this embodiment is utilized. As shown in FIG. 1, this embodiment is comprised of a server 10 comprising a database for storing and accumulating information resources and clients 20 for connecting to the server via a network 50 and obtaining information. The information processing system according to this embodiment automatically extracts a search condition of an information search based on an information activity performed on the clients 20 and performs a database search on the server 10 based on an extracted search condition so as to send the information searched for (search result) to the clients 20.

The server 10 is a database server implemented on a computer apparatus such as a workstation or a personal computer. The server 10 does not only read the information falling under the search condition of a search request from the database in response to the search request and responds to it but also has a function of performing the database search in predetermined timing based on the search condition registered in advance and sending it to the client 20 corresponding to the search condition.

The clients 20 are implemented on the computer apparatuses such as workstations or personal computers or information devices such as PDAs (Personal digital Assistants) or portable telephones with a network function. The clients 20 according to this embodiment are the clients in relation to the server 10, including terminal devices used by individual end users and a message server for managing exchange of messages between such terminal devices in an actual system configuration.

The network 50 may be either a public and wide-area network such as the Internet or a local network. To be more specific, it is possible either to construct the system of this embodiment with a public database server provided on the Internet as the server 10 or to construct it in a closed form such as an intranet.

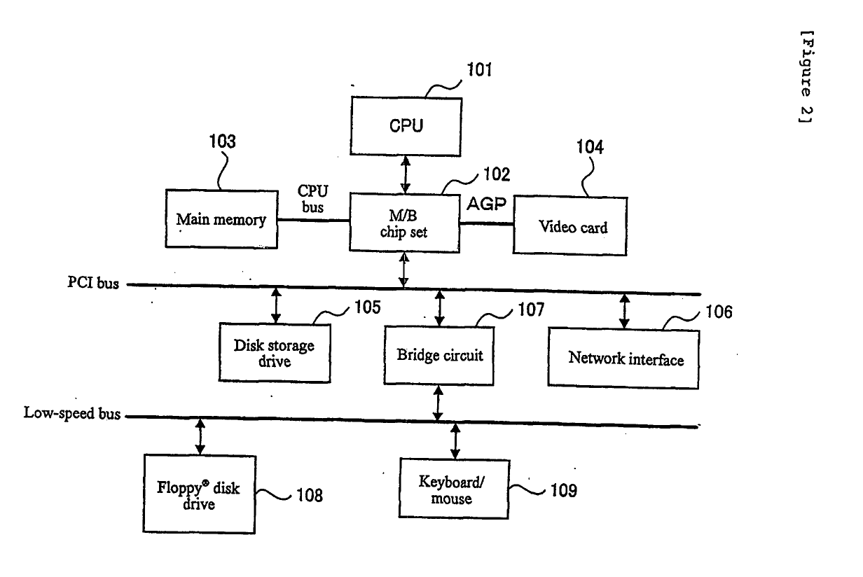

FIG. 2 is a diagram schematically showing an example of a hardware configuration of the computer apparatus suitable for implementing the server 10 and the clients 20 of this embodiment. The computer apparatus shown in FIG. 2 comprises a CPU (Central Processing Unit) 101 as calculation means, a main memory 103 connected to the CPU 101 via an M/B (motherboard) chip set 102 and a CPU bus, a video card 104 connected to the CPU 101 likewise via the M/B chip set 102 and an AGP (Accelerated Graphics Port), a disk storage drive (HDD) 105 connected to the M/B chip set 102 via a PCI (Peripheral Component Interconnect) bus, a network interface 106, and a floppy disk drive 108 and a keyboard/mouse 109 connected from the PCI bus to the M/B chip set 102 via a bridge circuit 107 and a low-speed bus such as an ISA (Industry Standard Architecture) bus.

FIG. 2 only illustrates the hardware configuration of the computer apparatus for implementing this embodiment, and other various configurations may be adopted if this embodiment is applicable. For instance, it is possible to mount only a video memory instead of providing the video card 104 and process image data with the CPU 101 or provide a CD-R (Compact Disc Recordable) or DVD-RAM (Digital Versatile Disc Random Access Memory) drive as an external storage via an interface such as ATA (AT attachment) or SCSI (Small Computer System Interface).

According to this embodiment, the exchange of messages between predetermined information devices is considered as the information activity on the clients 20 to extract the search condition on the server 10. As for means for exchanging the messages, various means are thinkable, such as e-mail, sending and receiving of the messages in cooperative work by using collaboration software, chatting and so on. However, considering that it is essential to give and receive the information by e-mail in operations of the enterprises nowadays, the case of using the e-mail will be described as an example of this embodiment. To be more specific, the information which is the search condition on the server 10 is extracted from the e-mail sent and received by the clients 20 so as to be sent to the server 10.

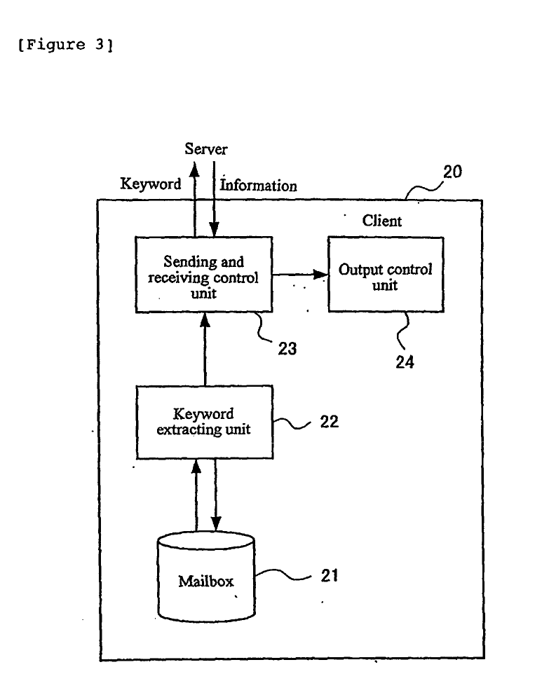

FIG. 3 is a diagram showing a functional configuration of the client 20 according to this embodiment. Referring to FIG. 3, the client 20 comprises a mailbox 21 having the e-mail sent and received stored therein, a keyword extracting unit 22 for extracting a keyword to be the search condition of the database search on the server 10 from the e-mail stored in the mailbox 21, a sending and receiving control unit 23 for controlling data exchange with the server 10, and an output control unit 24 for outputting the result of the database search on the server 10 received by the sending and receiving control unit 23.

In the configuration shown in FIG. 3, the mailbox 21 is implemented by the main memory 103 or the disk storage drive 105 of the computer apparatus in FIG. 2 for instance. The keyword extracting unit 22 is implemented by the program-controlled CPU 101 of the computer apparatus in FIG. 2 for instance. The sending and receiving control unit 23 is implemented by the program-controlled CPU 101 and the network interface 106 of the computer apparatus in FIG. 2 for instance. The output control unit 24 is implemented by the program-controlled CPU 101 and the video card 104 of the computer apparatus in FIG. 2 for instance. The program for implementing the functions of the keyword extracting unit 22, the sending and receiving control unit 23 and the output control unit 24 with the CPU 101 is provided by storing it in a magnetic disk, an optical disk, a semiconductor memory and other recording media and distributing it or delivering it via a network.

In the configuration of the client 20, the mailbox 21 accumulates the e-mail exchanged between the clients 20 and information devices such as the other terminal devices and server together with communication histories thereof. As for the mailbox 21, it is possible to apply an e-mail management function of e-mail software (mailer) which has been used so far.

The keyword extracting unit 22 searches the mailbox 21 in the predetermined timing (on system startup or periodically, for instance) to extract the keyword used for the database search on the server 10 from the stored e-mail.

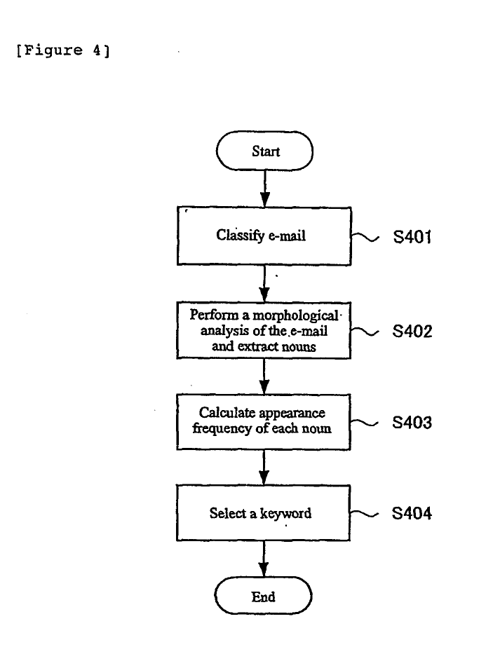

FIG. 4 is a flowchart for explaining a keyword extraction process by the keyword extracting unit 22. As shown in FIG. 4, the keyword extracting unit 22 first reconfigures all the e-mail stored in the mailbox 21 in the units of threads. And it classifies each thread based on an e-mail sending and receiving pattern as to whether the client 20 itself is a provider (seller) or a receiver (buyer) of the information in the thread (step 401).

To be more precise, in the case where a first action is the receiving and there is no subsequent action as to a predetermined thread, it is determined that the client 20 is the receiver of the information in the thread. As for an example of such a thread, there is the case of receiving mail of an information delivery service such as a mail magazine.

In the case where the first action is the receiving and the subsequent action is sending (return mail) to receiving, it is determined that the client 20 is the provider of the information in the thread. It is because, in such a thread, the e-mail is exchanged in the process of receiving an inquiry (receiving) first, replying (sending) and receiving a greeting of appreciation (receiving) in most cases. The cases of receiving first, and then exchanging the e-mail several times and ending with the receiving are considered likewise.

In the case where the first action is the sending and there is no subsequent action, it is determined that the client 20 is the provider of the information in the thread. As for an example of such a thread, there is the case of sending a notice from the client 20 to others.

In the case where the first action is the sending and the subsequent action is receiving to sending, it is determined that the client 20 is the receiver of the information in the thread. It is because, in such a thread, the e-mail is supposedly exchanged in the process of, as opposed to the previous case of receiving to sending to receiving, the client 20 makes an inquiry to others (sending), receiving responses thereto (receiving) and sending the greeting of appreciation (sending). The cases of sending first, and then exchanging the e-mail several times and ending with the sending are considered likewise.

In the case where the first action is the sending and the subsequent action is receiving to sending to receiving, it is determined that the client 20 is the provider of the information in the thread. It is because, in such a thread, the e-mail is supposedly exchanged in the process of sending some notice from the client 20 (sending), receiving an inquiry about it (receiving), replying (sending) and receiving the greeting of appreciation (receiving). The cases of sending first, and then exchanging the e-mail several times and ending with the receiving are considered likewise.

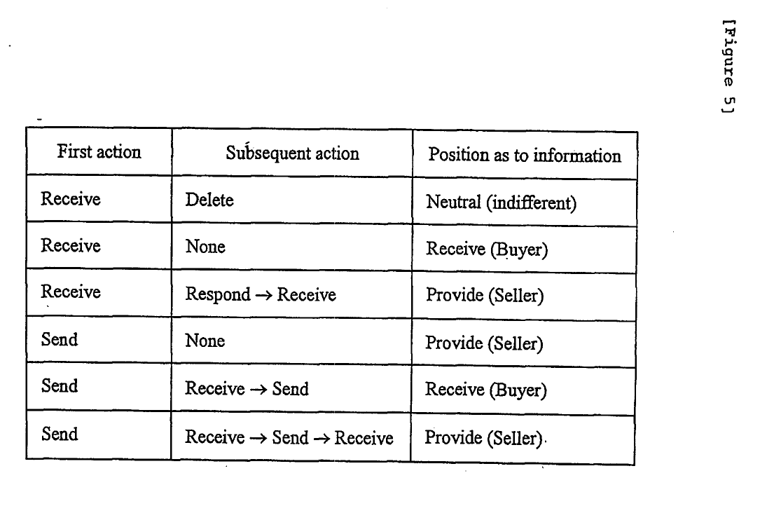

In the case where the first action is the receiving and the subsequent action is deletion of the received e-mail, it is considered that the received e-mail is unnecessary e-mail such as bulk mail, and so it is determined that the client 20 is neither the provider nor the receiver of the information. FIG. 5 is a table summarizing criteria of classification of the e-mail described above.

Next, the keyword extracting unit 22 selects the thread in which the client 20 is classified as the receiver of the information in the step 401, sequentially focuses attention on each of the selected threads and performs a morphological analysis of sentences of the e-mail included in each thread so as to extract nouns included in the sentences of the e-mail (step 402). And it calculates appearance frequency of each extracted noun (step 403). The appearance frequency of the nouns can be calculated as follows, for example.

First, importance of each thread is 1, and the importance is allocated to the nouns appearing in the thread according to the number of times of appearance thereof, which is the appearance frequency in the thread (appearance frequency by the thread). And it adds up the appearance frequencies by the thread of the same noun in all the threads in which the client 20 is in a position of the receiver of the information, which is the appearance frequency of the noun.

The calculation is performed as in the following example. As for a predetermined thread A in which the client 20 is determined to be the receiver of the information, it is assumed that a word “knowledge-management” appears seven times in total and a word “e-Learning” appears three times in total in the sentences of the e-mail included in the thread A. In this case, the number of times of appearance is 7 regarding “knowledge-management,” and 10 words (7+3) are extracted in total. Therefore, the appearance frequency by the thread thereof in the thread A is as follows.
7/(7+3)=0.7

Likewise, the appearance frequency of “e-Learning” by the thread in the thread A is as follows.
0.3 (=3/(7+3))

As for another thread B in which the client 20 is determined to be the receiver of the information likewise, it is assumed that the word “knowledge-management” appears three times in total and a word “investment-versus-effect” appears twice in total in the sentences of the e-mail included in the thread B. In this case, the appearance frequency by the thread of “knowledge-management” in the thread B is 0.6 (=3/(3+2)) as with the above calculation, and the appearance frequency by the thread of “investment-versus-effect” in the thread B is 0.4 (=2/(3+2)).

If the appearance frequencies by the thread of the same noun in the threads A and B are added up in the case where the threads in which the client 20 is in a position of the receiver of the information are only the threads A and B in the exchange of the e-mail, the appearance frequency by the thread of “knowledge-management” in the thread A is 0.7 and that in the thread B is 0.6. Therefore, the appearance frequency of “knowledge-management” is calculated as follows.
0.7+0.6=1.3

As “e-Learning” only appears in the thread A and “investment-versus-effect” only appears in the thread B, the appearance frequencies by the thread (0.3 for “e-Learning,” and 0.4 for “investment-versus-effect”) are the appearance frequencies of the nouns as-is.

Next, of the nouns in the sentences of the e-mail extracted by the morphological analysis in the step 402, the keyword extracting unit 22 eliminates very general words (“meeting,” “today,” “headquarters” and so on for instance) and selects as the keyword the ones of high appearance frequency out of the remaining words (step 404). Elimination of the general words can be performed by preparing a list of the words to be eliminated (dictionary) in advance and matching the nouns extracted in the step 402 to the list. It is also possible to automatically create this word list from the nouns extracted by the keyword extracting unit 22. For instance, there is an adoptable method such as selecting as the general words the words appearing at a high frequency to all the users in common irrespective of whether the receivers or providers of the information and registering them with the word list (to be more precise, it is possible to set up a criterion such as selecting as the general words several words of the highest frequency to 50 percent or more of all the users including the receivers and providers alike). A predetermined number of keywords are selected in lowering order of the appearance frequency of the words. The number of keywords to be selected is arbitrary and changeable. The selected keywords are sent to the server 10 by the sending and receiving control unit 23.

The above-mentioned keyword selection method and a word appearance frequency calculation method used therein are merely exemplifications. Any other arbitrary method may be adopted as long as it is the method capable of appropriately extracting the keyword used as the search condition for the database search on the server 10 from the e-mail accumulated in the mailbox 21.

The sending and receiving control unit 23 sends and receives data to and from the server 10 via the network 50, and sends the keyword extracted by the keyword extracting unit 22 to the server 10 or receives search information (results of the database search) sent from the server 10. The search information from the server 10 received by the sending and receiving control unit 23 is sent to the output control unit 24.

The output control unit 24 outputs the search information on the server 10 received from the sending and receiving control unit 23 to a display unit to display it thereon.

The keyword extracted by the keyword extracting unit 22 is extracted from the text obtained through the information activity (exchange of the e-mail) on the client 20. Therefore, it is necessary, on having the keyword sent to the server 10 by the sending and receiving control unit 23, to send to the server 10 the information for associating the keyword with the client 20 together so that the server 10 can recognize which client 20 the keyword is intended for. Here, the client 20 is the information device to be used by the end user according to this embodiment. However, it is the end user himself or herself rather than the information device that needs the information obtained by the database search. Thus, it is possible to associate, rather than the client 20, the information for identifying the end user using the client 20 with the keyword. To be more precise, an e-mail address of the end user is sent to the server 10 together with the keyword.

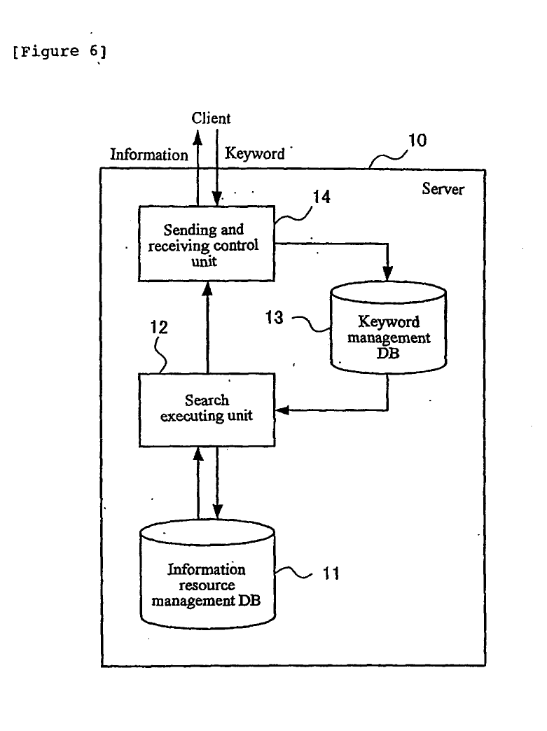

FIG. 6 is a diagram showing a functional configuration of the server 10 according to this embodiment. Referring to FIG. 6, the server 10 comprises an information resource management DB (database) 11 for storing the information resources, a search executing unit 12 for executing the database search for the information resource management DB 11, a keyword management DB (database) 13 for storing the keyword used for the database search by the search executing unit 12, and a sending and receiving control unit 14 for controlling data exchange between it and the clients 20.

In the configuration shown in FIG. 6, the information resource management DB 11 and the keyword management DB 13 are implemented by the main memory 103 and the disk storage drive 105 of the computer apparatus shown in FIG. 2 for instance. The search executing unit 12 is implemented by the program-controlled CPU 101 of the computer apparatus in FIG. 2 for instance. The sending and receiving control unit 14 is implemented by the program-controlled CPU 101 and the network interface 106 of the computer apparatus in FIG. 2 for instance. The program for implementing the functions of the search executing unit 12 and the sending and receiving control unit 14 with the CPU 101 is provided by storing it in a magnetic disk, an optical disk, a semiconductor memory and other recording media and distributing it or delivering it via a network.

In the configuration of the server 10, the information resource management DB 11 stores the information resources as a subject of the database search on the server 10.

The search executing unit 12 executes the database search for the information resource management DB 11 by using the keyword stored in the keyword management DB 13. The search of the information resource management DB 11 by the search executing unit 12 is repeatedly executed in predetermined timing (periodically, for instance). Thus, a search is made at any time in the case where a newly registered information resource falling under a predetermined keyword exists in the information resource management DB 11.

The keyword management DB 13 classifies and stores the keywords sent from the client 20 for each end user by using the e-mail address.

The sending and receiving control unit 14 sends and receives the data to and from the client 20 via the network 50, and receives the keyword sent from the client 20 to store it in the keyword management DB 13 or sends the information searched for by the search executing unit 12 to an applicable e-mail address.

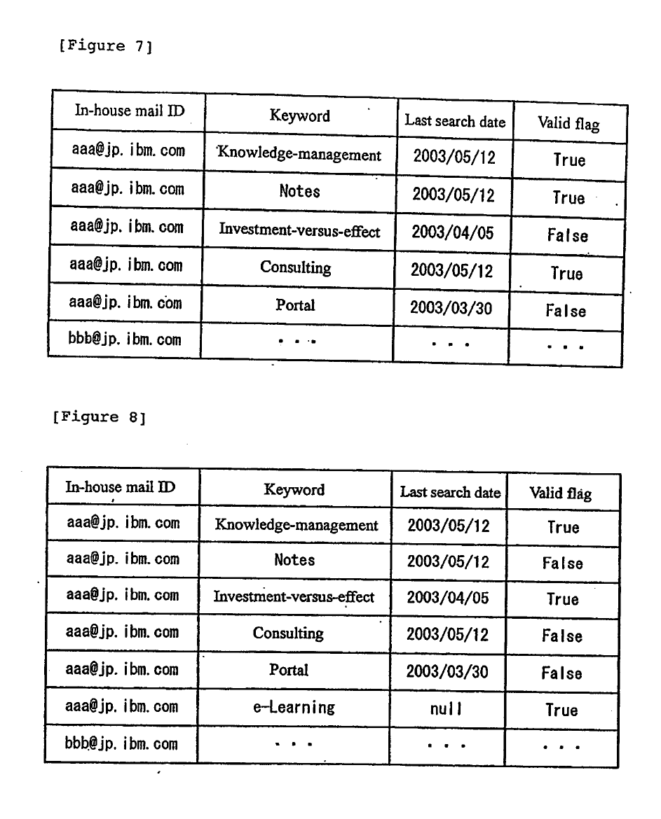

FIG. 7 is a diagram showing a configuration example of the data to be stored in the keyword management DB 13. As shown in FIG. 7, the keyword management DB 13 stores an in-house mail ID (e-mail address) for identifying the end user as the user of the information, the keyword as the search condition, a last search date for the keyword and a valid flag by relating them.

Here, ID information other than the e-mail address may be used as the information for identifying the end user. However, it is possible, by using the e-mail address, to notify the search result of the information resource management DB 11 by sending to it that e-mail address. The e-mail address can be obtained together when the keyword is sent from the client 20, for instance.

The last search date is the date on which the search of the information resource management DB 11 was performed last with the keyword, and the search executing unit 12 searches for the information registered with the information resource management DB 11 on and after the last search date. Thus, it is possible to avoid redundantly searching for the information searched for in the past and sensing it to the client 20.

The valid flag is a flag for differentiating the keyword actually used by the search executing unit 12 on performing the search on the information resource management DB 11 (True) and the keyword not used for that search (False). For instance, in the case where the number of valid keywords for each e-mail address is set at three, the valid flags of three of the keywords associated with the same e-mail address become True (in the shown example, the three keywords of “knowledge-management,” “Notes” and “consulting” are True, out of the keywords associated with the e-mail address “aaa@jp.ibm.com”).

Consideration is given to the case where the keywords associated with a predetermined e-mail address are stored in the keyword management DB 13 of the server 10 and the keywords associated with the e-mail address are further inputted newly via the sending and receiving control unit 14 (as mentioned above, the keywords are sent from the client 20 each time the system is started up for instance). In this case, the keywords associated with the e-mail address in the keyword management DB 13 are updated with the newly inputted keywords. Here, it is assumed, for instance, that the three keywords of “knowledge-management,” “investment-versus-effect” and “e-Learning” are sent from the client 20 used by the end user identified by “ ” in certain timing.

FIG. 8 is a diagram showing an appearance of having updated the keywords associated with the e-mail address “ ” in the keyword management DB 13 in FIG. 7. If FIG. 8 is compared to FIG. 7, the word “e-Learning” is added as the keyword corresponding to the e-mail address “ ” (the last search date is null because it is a newly added keyword). And the valid flags of the three keywords of “e-Learning” which was added, “knowledge-management” and “investment-versus-effect” are True. And the valid flags of the keywords “Notes” and “consulting” are changed to False. To be more specific, the three current keywords sent from the client 20 are valid, and the two keywords except “knowledge-management” also included in the current keywords are invalid as old keywords.

Here, the old keywords are switched between valid and invalid by the valid flags instead of being deleted from the keyword management DB 13. It is for the purpose of preventing the information resource management DB 11 from being redundantly searched in the case where the keywords are sent again later as the current keywords from the client 20.

As a concrete example, consideration is given to the keyword “investment-versus-effect” of which valid flag is False in FIG. 7 and True in FIG. 8. At the time in FIG. 7, the three keywords of “knowledge-management,” “Notes” and “consulting” are True, and the keyword “investment-versus-effect” is False as the old keyword. In the case where this keyword “investment-versus-effect” is deleted from the keyword management DB 13, the keyword “investment-versus-effect” is sent as the current keyword from the client 20 at a next update as in FIG. 8, and so this keyword is registered with the keyword management DB 13 anew. Then, the search executing unit 12 searches for all the information falling under the new keyword “investment-versus-effect” out of the information resources registered with the information resource management DB 11 anew.

However, the keyword “investment-versus-effect” was previously registered as the keyword, and the information falling under this keyword was already searched for and sent to the client 20 at that time. Therefore, if all the information resources registered with the information resource management DB 11 are searched for and sent to the client 20 when the keyword “investment-versus-effect” is registered again, the information previously sent to the client 20 becomes redundant. Thus, according to this embodiment, the old keywords are not deleted from the keyword management DB 13 but only the valid flags are excluded from the search conditions as False, and the information on the last search date searched for with the keyword is held so that only the information resources stored in the information resource management DB 11 on and after the last search date is searched for when the keyword becomes True next. As for the example shown in FIG. 8, the last search date of the keyword “investment-versus-effect” is Apr. 5, 2003. Therefore, the information resources registered with the information resource management DB 11 on and after this date are searched for so as to send the information falling under the keyword “investment-versus-effect,” if any, to the client 20.

According to the information processing system of this embodiment constituted as above, the search request for the database search is not sent from the client 20 but the information considered useful to the end user of the client 20 is sent from the server 10 to the client 20 at any time.

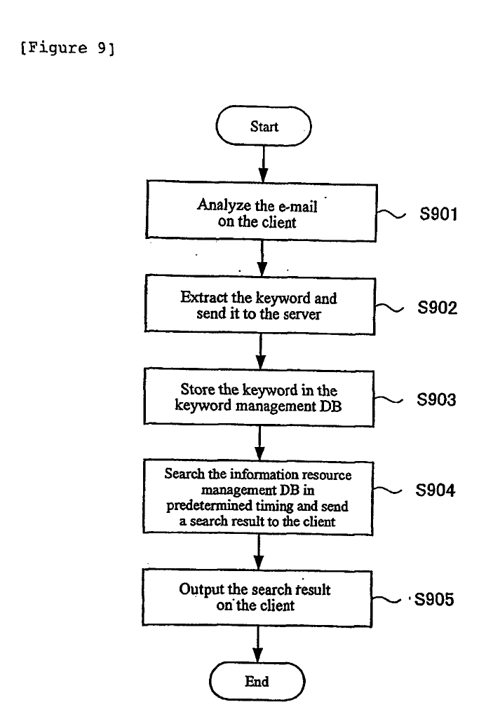

FIG. 9 is a flowchart showing an overall processing flow of the information processing system of this embodiment. As shown in FIG. 9, in the predetermined timing (on system startup or periodically), the client 20 has the threads of the e-mail stored in the mailbox 21 analyzed, and has the thread in which the client 20 is determined to be the receiver (buyer) of the information selected so as to have the morphological analysis performed as to the text of the e-mail included in the thread (step 901). And it is decomposed into the words and the appearance frequency of each word (noun) is calculated so that the keywords are selected and sent to the server 10 together with the e-mail address of the end user of the client 20 (step 902).

The keywords sent to the server 10 from the client 20 are classified according to the e-mail addresses obtained together with the keywords, and are stored in the keyword management DB 13 of the server 10 (step 903). And the information resource management DB 11 is searched by the search executing unit 12 by using the keywords stored in the keyword management DB 13 as the search conditions in preset and predetermined timing (at a fixed time every day for instance) so that the information obtained as the search result is sent to the client 20 (step 904). The client 20 has the information sent from the server 10 outputted and displayed thereon so as to notify the end user thereof (step 905).

According to the above example of the operation, the server 10 performs the search of the information resource management DB 11 in the preset and predetermined timing. However, it is also possible, when the new keywords are sent from the client 20, to perform the database search by using the new keywords.

In addition, according to the above example, the client 20 has the information as the search result outputted and displayed thereon after receiving it. However, it is also possible to store the information itself in the predetermined storing means and notify the end user only of the reception of the information by display or voice. Furthermore, in order to send the information as the search result to the e-mail address associated with the keyword, it is also possible for the end user to obtain the information from the information device other than his or her own client 20 by using the e-mail address.

Furthermore, this embodiment has been described by taking the example in which the client 20 is the information device to be used by the end user. However, it is also possible to use a mail server for managing the exchange of the e-mail as the client 20. In this case, the mail server as the client 20 analyzes the threads of the exchange of the e-mail managed by it, extracts the keywords and sends them to the server 10. And it sends the information sent from the server 10 to a user terminal in a position of the receiver of the information in the thread from which the keywords were extracted out of the user terminals which are the clients to the mail server.

According to the embodiment, the exchange of the e-mail is considered as an example of the information activity of the client 20. However, as to the present invention in essence, the keywords are extracted from the text obtained through the information activity on the client and are sent to the server 10 so that, even if the end user of the client 20 sets no search condition of the database search by his or her active operations, the search is automatically performed by the server 10 so as to provide the information considered useful to the end user. Therefore, the contents of the information activity are not limited to the above-mentioned exchange of the e-mail. Hereafter, a description will be given as to the embodiment of which concept of the information activity of the client 20 is the cooperative work by a plurality of computers by using the collaboration software.

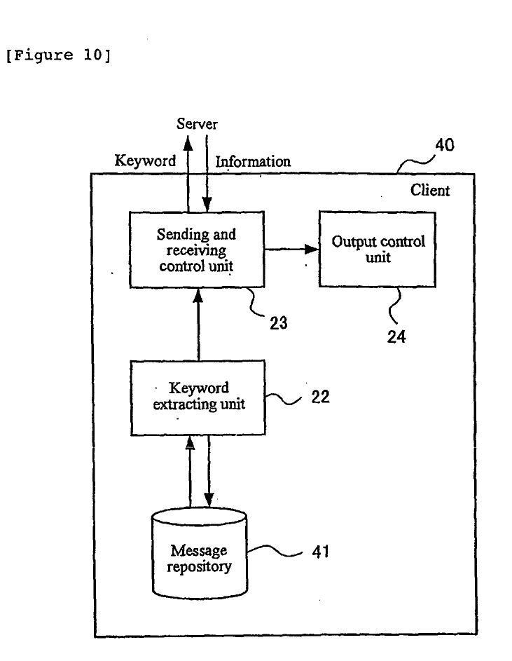

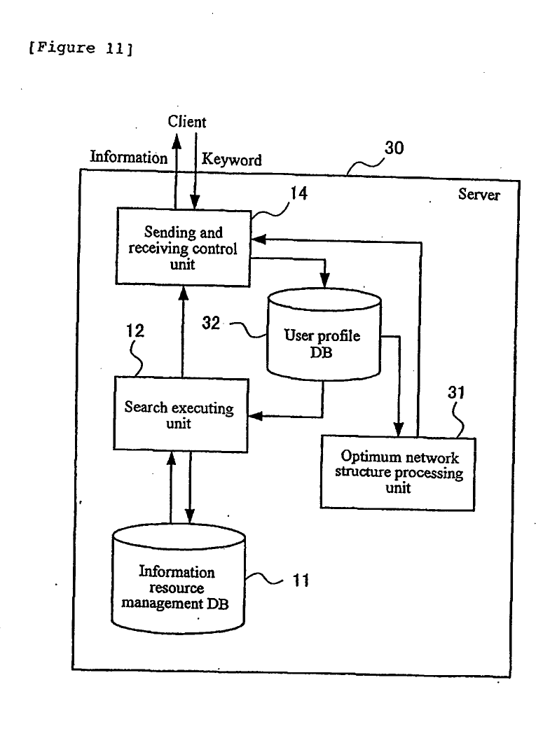

FIG. 10 is a diagram showing the functional configuration of the client in the case where the information activity of the client is the cooperative work by a plurality of computers by using the collaboration software. FIG. 11 is a diagram showing the functional configuration of the server in the same case.

As shown in FIG. 10, compared to the client 20 shown in FIG. 3, a client 40 according to this embodiment comprises a message repository 41 storing a nontypical message exchanged in the cooperative work by the collaboration software instead of the mailbox 21. Otherwise, the configuration is the same as the client 20 shown in FIG. 3.

In the case of the nontypical message stored in the message repository 41, however, it is not possible to directly analyze the patterns of sending and receiving (refer to FIG. 5) as the patterns of a direct information activity as with the e-mail and determine whether the client 40 is the provider or the receiver of the information. Thus, to analyze the patterns of the information activity on the client 40, the keyword extracting unit 22 first analyzes the sentences of each nontypical message stored in the message repository 41 as preprocessing to detect question words and question marks such as “is it?,” “isn't it” and “?”. Next, it refers to a tree structure of the message and counts the number of the question words and question marks appearing in the message sent by the client 40. And in the case where the number of the question words and question marks appearing is large (in the case of a predetermined number (threshold) or more, for instance), it determines that the client 40 is in a position of the receiver of the information in the exchange of one message thereof.

Thereafter, the operation for performing the morphological analysis of the message and extracting the keywords is almost the same as the processing by the keyword extracting unit 22 shown in FIG. 4. According to this embodiment, however, the keywords are extracted not only in the case where the client 40 is the receiver of the information but also in the case where it is the provider of the information, and identification data for identifying whether it is the receiver or the provider is sent to the server 10 together with the keywords.

As shown in FIG. 11, a server 30 according to this embodiment comprises an optimum network structure processing unit 31 in addition to the information resource management DB 11, the search executing unit 12 and the sending and receiving control unit 14 as with the server 10 shown in FIG. 6. It also comprises a user profile DB 32 instead of the keyword management DB 13.

The optimum network structure processing unit 31 is implemented by the program-controlled CPU 101 of the computer apparatus shown in FIG. 2 for instance.

The user profile DB 32 stores and holds the keywords as with the keyword management DB 13 in the server 10 shown in FIG. 6, and also stores the identification data indicating whether the client 40 having sent the keywords is the receiver or the provider of the information as to the keywords. And the search executing unit 12 executes the search of the information resource management DB 11 only for the keywords sent from the client 40 as the receiver of the information.

The optimum network structure processing unit 31 searches the user profile DB 32, and checks as to the predetermined keywords whether there are the registrations by the sending from the client 40 as the receiver of the information and the registrations by the sending from the client 40 as the provider of the information. In the case where such registrations of the keywords exist, the optimum network structure processing unit 31 sends the information on the client 40 as the provider of the information (the e-mail address for exchanging the messages and so on) to the client 40 as the receiver of the information as to the keywords. This sending of the information on the provider of the information may be performed together when sending the search results related to the keywords for instance.

The client 40 obtains the search results related to the keywords and also the information on the client 40 as the provider of the information as to the keywords, and is thereby able to directly exchange the messages with the client 40 as the provider of the information so as to obtain desired information.

The embodiments of the present invention were described above. It goes without saying, however, that technical idea of the present invention is not limited to the above embodiments. For instance, according to the embodiments, the client comprises the means for extracting the keywords. However, the server itself may have a keyword extracting function in the case of the information processing system in which the server manages the text obtained as a result of the information activity on the client. Thus, it is possible to adopt various system configurations appropriately combining hardware and software in a range not exceeding the technical idea of the present invention.

The present invention can be realized in hardware, software, or a combination of hardware and software. It may be implemented as a method having steps to implement one or more functions of the invention, and/or it may be implemented as an apparatus having components and/or means to implement one or more steps of a method of the invention described above and/or known to those skilled in the art. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or after reproduction in a different material form.

Thus the invention includes an article of manufacture which comprises a computer usable medium having computer readable program code means embodied therein for causing one or more functions described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1) An information processing apparatus comprising:
a text holding unit for holding text obtained through a predetermined information activity;
a keyword extracting unit for analyzing a pattern of the information activity to specify a method of extracting a keyword to be used for a database search based on the analysis result, and extracting the keyword from the text held by the text holding unit by the specified extracting method; and
an output control unit for outputting the result of the database search using the keyword extracted by the keyword extracting unit.

2) The information processing apparatus according to claim 1, wherein the keyword extracting unit selects as a subject of extraction of the keyword the text determined to have been obtained through the information activity performed to obtain predetermined information based on the analysis result of the pattern of the information activity.

3) The information processing apparatus according to claim 1, wherein the keyword extracting unit extracts as the keyword a word obtained by performing a morphological analysis of the text held by the text holding unit.

4) The information processing apparatus according to claim 3, wherein, of words obtained from the text, the keyword extracting unit extracts as the keywords a predetermined number of words of a high frequency of appearance.

5) The information processing apparatus according to claim 1, wherein the text holding unit is a mailbox having e-mail exchanged with external devices stored therein.

6) The information processing apparatus according to claim 5, wherein the keyword extracting unit analyzes sending and receiving actions of the e-mail stored in the text holding unit and selects the e-mail selected based on the analysis result as a subject of extraction of the keyword.

7) The information processing apparatus according to claim 5, wherein the keyword extracting unit analyzes sending and receiving actions of the e-mail stored in the text holding unit and selects the e-mail in the thread as a subject of extraction of the keyword in the case where the sending and receiving actions of the e-mail in a predetermined thread start with receiving only or sending and ends with the sending after a predetermined number of times of the sending and receiving.

8) The information processing apparatus according to claim 5, wherein the keyword extracting unit analyzes sending and receiving actions of the e-mail stored in the text holding unit and determines for each thread whether the sending and receiving have been performed to provide predetermined information or to obtain the predetermined information, and extracts the keyword from predetermined e-mail based on the determination result.

9) An information processing apparatus comprising:
a text holding unit for holding a text obtained through a predetermined information activity;
a keyword extracting unit for analyzing a pattern of the information activity to specify a method of extracting a keyword to be used for a database search based on the analysis result, and extracting the keyword from the text held by the text holding unit by the specified extracting method; and
a communication control unit for sending the keyword extracted by the keyword extracting unit as a search condition to a database server on a network.

10) The information processing apparatus according to claim 9, wherein the keyword extracting unit selects as a subject of extraction of the keyword the text determined to have been obtained through the information activity performed to obtain predetermined information based on the analysis result of a pattern of the information activity.

11) The information processing apparatus according to claim 9, wherein the keyword extracting unit extracts as a keyword a word obtained by performing a morphological analysis of the text held by the text holding unit.

12) An information processing system comprising:
a database server and a client connected to the database server via a network; wherein
the client specifies a method of extracting a keyword to be used for a database search based on a pattern of a predetermined information activity, extracts the keyword from a text obtained through the information activity by the specified extraction method and sends the keyword to the database server; and
the database server receives the keyword sent by the client, performs the database search using the keyword as a search condition and sends the search result to the client.

13) The information processing system according to claim 12, wherein the database server holds the keyword received from the client, and in the case where new information related to the keyword is registered with a database, the database server sends the new information to the client.

14) The information processing system according to claim 12, wherein the database server holds the keyword received from the client, performs the database search in preset timing and sends the search result to the client.

15) The information processing system according to claim 12, wherein the client extracts the keyword from e-mail exchanged with external devices; and
the database server classifies and holds the keyword received from the client based on an e-mail address of an end user using the client, and sends the database search result based on the keyword to the e-mail address.

16) The information processing system according to claim 12, wherein, as to the keyword, the client further sends to the database server information indicating whether the client apparatus has been a receiver or a provider of the information in the information activity through which a text as a source of extraction of the keyword has been obtained; and
as to a predetermined keyword of the keywords sent from the client, the database server sends information on the client having sent the keyword as the provider of the information to the client having sent the keyword as the receiver of the information.

17) A database search method for searching a database constructed by using a computer; the method comprising the steps of:
extracting, from a text obtained through a predetermined information activity and stored in predetermined text storing means, a keyword to be used for a database search by a keyword extracting method specified based on the analysis result of a pattern of the information activity;
storing the extracted keyword in predetermined keyword storing means; and
performing a database search by using the keyword stored in the keyword storing means.

18) The database search method according to claim 17 in the step of extracting the keyword includes a step of extracting a word obtained by performing a morphological analysis of the text as the keyword.

19) The database search method according to claim 17, wherein the step of performing the database search is repeated in preset and predetermined timing so as to search newly registered information falling under the keyword at any time.

20) A program product causing a computer to execute processes of:
specifying a method of extracting a keyword to be used for a database search based on the analysis result by analyzing a pattern of the information activity, with information obtained through a predetermined information activity and stored in predetermined storing means;
extracting the keyword from a text obtained through the information activity by the extracting method; and
outputting the extracted keyword as a search condition for the database search.

21) The program product according to claim 20 for, in the process of specifying a method of extracting a keyword, classifying the texts stored in the storing means into the text determined to have been obtained through the information activity performed to obtain the predetermined information and the text determined to have been obtained through other information activities, and selecting as a subject of extraction of the keyword the text determined to have been obtained through the information activity performed to obtain the predetermined information.

22) The program product according to claim 20 for, in the process of extracting the keyword, extracting as the keyword a word obtained by performing a morphological analysis of the text held by the storing means.

23) The program product according to claim 22 for, in the process of extracting the keyword, extracting as the keywords a predetermined number of words of a high frequency of appearance out of the words obtained from the text.

24) The program product according to claim 20 for, in the process of specifying a method of extracting a keyword, analyzing sending and receiving actions of e-mail stored in a mailbox and selecting the e-mail in the thread as a subject of extraction of the keyword in the case where sending and receiving actions of the e-mail in a predetermined thread start with receiving only or sending and end with the sending after a predetermined number of times of the sending and receiving.

25) The program product according to claim 20 for, in the process of specifying a method of extracting a keyword, analyzing the sending and receiving actions of e-mail stored in a mailbox and determining for each thread whether the sending and receiving have been performed to provide predetermined information or to obtain the predetermined information, and selecting the predetermined e-mail as a subject of extraction of a keyword based on the determination result.

26) An article of manufacture comprising a computer usable medium having computer readable program code means embodied therein for causing search of a database, the computer readable program code means in said article of manufacture comprising computer readable program code means for causing a computer to effect the steps of claim 17.

27) A program storage device readable by machine, tangibly embodying a program of instructions executable by the machine to perform method steps for searching a database, said method steps comprising the steps of claim 17.

28) A computer program product comprising a computer usable medium having computer readable program code means embodied therein for causing information processing, the computer readable program code means in said computer program product comprising computer readable program code means for causing a computer to effect the functions of claim 1.

29) A computer program product comprising a computer usable medium having computer readable program code means embodied therein for causing information processing, the computer readable program code means in said computer program product comprising computer readable program code means for causing a computer to effect the functions of claim 12.
